(19) United States
(12) Patent Application Publication
(10) Pub. No.: US 2025/0197281 A1
(43) Pub. Date: Jun. 19, 2025

(54) LOW-CARBON PRODUCTION METHOD AND SYSTEM FOR CEMENT CLINKER

(71) Applicant: EAST CHINA UNIVERSITY OF SCIENCE AND TECHNOLOGY, Shanghai (CN)

(72) Inventors: Jun HU, Shanghai (CN); Feng QIAN, Shanghai (CN); Bin SHAO, Shanghai (CN); Wenli DU, Shanghai (CN); Yuanming ZHU, Shanghai (CN); Zhicheng XIE, Shanghai (CN); Weimin ZHONG, Shanghai (CN); Honglai LIU, Shanghai (CN)

(21) Appl. No.: 18/843,989

(22) PCT Filed: Mar. 3, 2023
(86) PCT No.: PCT/CN2023/079584

§ 371 Date: Sep. 4, 2024

(30) Foreign Application Priority Data
Mar. 4, 2022 (CN) 202210212634.8

(51) Int. Cl. C04B 7/42; B01J 8/02; C01B 3/34; C01B 3/36; C04B 7/43; C04B 7/44; C04B 7/47; F27B 7/00

(52) U.S. Cl. CPC C04B 7/428; B01J 8/0278; B01J 8/0285; C01B 3/344; C01B 3/36; C04B 7/434; C04B 7/44; C04B 7/475; F27B 7/00; B01J 2208/00309; B01J 2208/00504; C01B 2203/0244; C01B 2203/0255; C01B 2203/0811; C01B 2203/0883; C01B 2203/1241; F27M 2003/03

(57) ABSTRACT

A low-carbon production method and production system for cement clinker. The production method comprises calcining a metal oxide, which is obtained by converting carbonate in a raw material by means of a methane dry reforming reaction, to form cement clinker, and meanwhile obtaining synthesis gas. The production system uses a reformer furnace for methane dry reforming of carbonate to replace a carbonate decomposition furnace in an existing cement production system.

### FIELD OF THE INVENTION

The present invention relates to the technical field of cement production, and particularly to a production method and system that utilize direct carbonate dry reforming of methane and partial oxidation of methane for heat supply.

### BACKGROUND

As a carbon-intensive industry, cement production needs to reduce carbon emissions during its production process. At present, all cement companies in China have adopted dry production technology, that is, the raw material (limestone accounting for 90%) that has been preheated and dried by a preheater is first introduced into a decomposition furnace at 860-900° C. to pre-decompose into metal oxides (the decomposition rate can reach 85%-95%) such as calcium oxide, accompanied by a large amount of carbon dioxide emissions, and then the metal oxides are introduced into a rotary kiln at 1600° C. for further calcining into cement clinker for storage. As a result, in the process of producing 1 ton of cement, about 376.7 kg of CO₂ is produced due to the decomposition of calcined calcium carbonate in the decomposition furnace, about 193 kg of CO₂ is emitted due to the coal consumption for maintaining high temperature in the rotary kiln, and the comprehensive power consumption (excluding waste heat power generation) is converted into carbon emissions of about 46.9 kg. Therefore, carbon emissions in a decomposition furnace accounts for about 62% of total carbon emissions in cement production, which is a huge amount of carbon emissions. The carbon reduction in a decomposition furnace section is crucial for a carbon neutrality process of the cement industry.

At present, the cement production process mainly adopts low-carbon cement technology (such as the development of calcium-free carbon-negative cement, calcium sulfosilicate cement, carbonized calcium silicate cement, etc.) and raw material substitution technology (such as the use of steel slag, carbide slag, slag, pulverized coal slag, silicon calcium slag, etc. to replace traditional limestone as raw material). To address the carbon emissions problem of coal burning, alternative fuels or green fuel technologies (such as using biomass fuel, combustible waste gas, hydrogen and other new energy sources to replace traditional coal burning as alternative fuel for cement production) are adopted. To address the carbon emissions problem of electricity consumption, green power generation technologies such as wind power generation and solar power generation are adopted. And joint deployment of CCUS technology for carbon emissions (such as membrane adsorption method, oxygen combustion capture, post-combustion capture, calcium cycling method, etc.) are adopted throughout the cement production process. However, these cement carbon emissions reduction technologies only reduce CO₂ emissions from the fuel part or terminal treatment (capture and store the emitted carbon dioxide), and do not truly realize the resource utilization of carbon dioxide. The economic benefits are low and it is difficult to carry out large-scale commercial deployment.

Therefore, there is an urgent need in this field to provide a new carbon neutrality approach to the cement industry. In addition to the metal oxides that can be used to burn cement clinker, through the new approach, the obtained products can also be used to comprehensively produce raw materials for other chemical platform, and there is almost no carbon dioxide emissions.

### SUMMARY

The present invention aims to provide a new approach to cement production with almost no carbon dioxide emissions, in response to shortcomings of carbon emissions reduction technology in the existing cement production process.

In a first aspect of the present invention, a method for producing cement clinker is provided, wherein the method comprises the following steps: converting carbonates in a raw material into metal oxides by means of dry reforming of methane, and then calcining the metal oxides to form cement clinker.

In another embodiment, the method further obtains syngas through the dry reforming of methane.

In another embodiment, heat required for the dry reforming of methane is generated by subjecting methane feed gas to partial oxidation reaction of methane.

In another embodiment, a temperature of the dry reforming of methane is at least 600° C., such as but not limited to, 650-800° C., 700° C.-1200° C., 950-1300° C., etc.

In another embodiment, a molar ratio of methane feed gas, oxygen and carbonates is (1.5-4.0):(1.5-3.5):1.

In a second aspect of the present invention, a production system for cement clinker is provided, wherein the system comprises a preheater, a reformer furnace, a rotary kiln and a grate cooler arranged in sequence in a direction of material flow.

In another embodiment, the reformer furnace comprises a furnace body, a syngas heat exchanger at an outlet, and a methane feed gas preheating heat exchanger at an inlet. Besides, a cement raw material inlet, a syngas outlet, a catalytic reaction bed, a combustion chamber, a preheated methane feed gas inlet, an oxygen inlet and a cement clinker discharge outlet are arranged in the furnace body from top to bottom.

In another embodiment, the system further comprises a feeding bin installed in front of the preheater.

In a third aspect of the present invention, a use of the production system provided by the present invention as described above is provided.

In another embodiment, the production comprises cement production, and the cement comprises cement clinker.

In another embodiment, the production system is used for conversion by means of carbonate dry reforming of methane.

In a fourth aspect of the present invention, a method for preparing cement clinker using the production system provided by the present invention as described above is provided, wherein the method comprises the following steps:
(1) feeding raw material preheated by a preheater into a reformer furnace through a cement raw material inlet and converting into metal oxides through dry reforming of methane;
(2) calcining the metal oxides in a rotary kiln to obtain cement clinker.

In another embodiment, a syngas with a temperature of 600-700° C. produced by a conversion reaction in the reformer furnace preheats a raw material in the preheater to 450-550° C.

In another embodiment, part of heat required for a conversion reaction in the reformer furnace comes from a partial oxidation reaction of a preheated methane feed gas and oxygen introduced into a lower part of the reformer furnace.

In another embodiment, the preheated methane feed gas is obtained by heating a methane feed gas with a flue gas with a temperature of 1100-1300° C. from the rotary kiln in a heat exchanger.

In another embodiment, a molar ratio of the methane feed gas to the flue gas with a temperature of 1100-1300° C. from the rotary kiln is 0.5-1.5:1, preferably 1-1.5:1.

In another embodiment, a molar ratio of the preheated methane feed gas introduced into the lower part of the reformer furnace, the introduced oxygen and carbonates in raw material is (1.5-4.0):(1.5-3.5):1.

In another embodiment, the step (2) further comprises cooling the calcined cement clinker in a grate cooler.

Therefore, the present invention provides a new carbon neutrality approach to cement industry, wherein in addition to the metal oxides that can be used to burn cement clinker, the obtained products can also be used to comprehensively produce raw materials for other chemical platform, and there is almost no carbon dioxide emissions.

### BRIEF DESCRIPTION OF THE FIGURES

FIG. 1 is a schematic diagram of a process and system for direct carbonate dry reforming of methane in a cement production process based on carbon neutrality according to the present invention.

FIG. 2 is a schematic diagram of a reformer furnace in a cement production process of the present invention; wherein,

1—raw material pipeline, 2—feed inlet, 3—high-temperature syngas outlet, 4—catalytic reaction bed, 5—reactor furnace body, 6—combustion chamber, 7—gas distributor, 8—oxygen inlet, 9—methane feed gas inlet, 10—heat exchanger, 11—high-temperature flue gas inlet, 12—discharge outlet, 13—metal oxide outlet (to a rotary kiln), 14—flue gas outlet, 15—burner.

### DETAILED DESCRIPTION

After extensive and in-depth research, the present invention controls carbon emissions from source and modifies existing decomposition furnace system, enabling direct calcium carbonate dry reforming of methane to co-produce metal oxides such as calcium oxide and syngas, in response to the problems of high carbon emissions intensity and energy consumption in the calcination and decomposition process of calcium carbonate in the current decomposition furnace. Based on the existing dry-process cement production technology, a decomposition furnace with high carbon emissions is transformed into a reformer furnace, and a process coupled strongly exothermic partial oxidation reaction of methane and a strongly endothermic direct carbonate dry reforming of methane is used, wherein part of methane generates oxidation reaction heat to provide required energy for a reformer furnace, and part of methane and cement raw material carbonates undergo a reforming reaction and is converted in situ into syngas and metal oxides such as calcium oxide. A hydrogen-to-carbon ratio of syngas is controlled by adjusting a flow ratio of methane to carbonates, and reaction heat balance is controlled by adjusting a flow ratio of methane and oxygen. On this basis, the present invention was completed.

As used in the present invention, “cement clinker” and “cement” can be used interchangeably, both of which refer to substances obtained from raw material and mainly composed of CaO·SiO₂·Al₂O₃ and Fe₂O₃ (with a total content of usually more than 95%); wherein CaO·SiO₂·Al₂O₃ and Fe₂O₃ do not exist as single oxide, but are aggregates of various minerals generated by high-temperature chemical reaction of two or more oxides, wherein the aggregates mainly comprise tricalcium silicate (3CaO·SiO₂), dicalcium silicate (2CaO·SiO₂), tricalcium aluminate (3CaO·Al₂O₃) and tetracalcium aluminoferrite (4CaO·Al₂O₃·Fe₂O₃).

As used in the present invention, “raw material” refers to a material composed of carbonates, cement calibration raw material, metal catalyst, etc. In one embodiment of the present invention, main component of raw material is carbonates, which can be, but are not limited to, limestone, marl, marble and other calcareous raw material. A cement calibration raw material can be one or more of steel slag, sulfuric acid slag, bauxite, fly ash, clay and the like. A metal catalyst can be one or more combinations of oxides of non-noble metals such as iron, nickel, cobalt, copper, zinc, zirconium, cesium, magnesium, calcium, etc. Carbonates include, but are not limited to, calcium carbonate, magnesium carbonate, barium carbonate, lithium carbonate, potassium carbonate, sodium carbonate, calcium bicarbonate, potassium bicarbonate, iron carbonate, barium carbonate, cadmium carbonate, zinc carbonate, lead carbonate and copper carbonate, etc.

### Production System

The present invention provides a production system for cement clinker, comprising a preheater, a reformer furnace connected to an outlet of the preheater, and a rotary kiln connected to an outlet of the reformer furnace.

Furthermore, a heat exchanger can be installed between the reformer furnace and the rotary kiln in the production system. A methane feed gas inlet, a flue gas outlet and an inlet for a high-temperature flue gas from the rotary kiln are distributed on the heat exchanger.

Further, the production system may further include a grate cooler connected to a lower portion of the rotary kiln, and a separation tank connected to an upper portion of the preheater.

In one embodiment of the present invention, the production system may further comprise a feeding bin for storing raw material, a pipeline for conveying raw material to the preheater, a container for storing cement clinker, and a pipeline for conveying cooled cement clinker from the grate cooler to the container, etc.

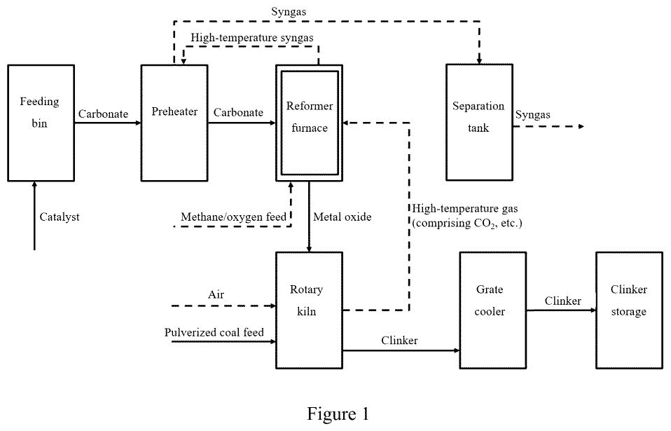

In one embodiment of the present invention, the production system is schematically illustrated in FIG. 1.

The preheater, the rotary kiln and the like comprised in the production system provided by the invention can be conventionally used in the field.

The reformer furnace (or called a reformer furnace reactor) in the production system provided by the invention comprises a furnace body and a feed inlet, a high-temperature syngas outlet, a catalytic reaction bed, a combustion chamber, a gas distributor, a burner, a preheated methane feed gas inlet and a discharge outlet which are arranged in the furnace body from top to bottom.

In one embodiment of the present invention, the furnace body of the reformer furnace is resistant to high temperatures (>800° C.) and has good gas tightness. The reformer furnace may be, but is not limited to, a fixed bed, a tubular reactor, a moving bed, a rotary kiln, a turbulent bed, a bubbling bed, a spouted bed, and the like.

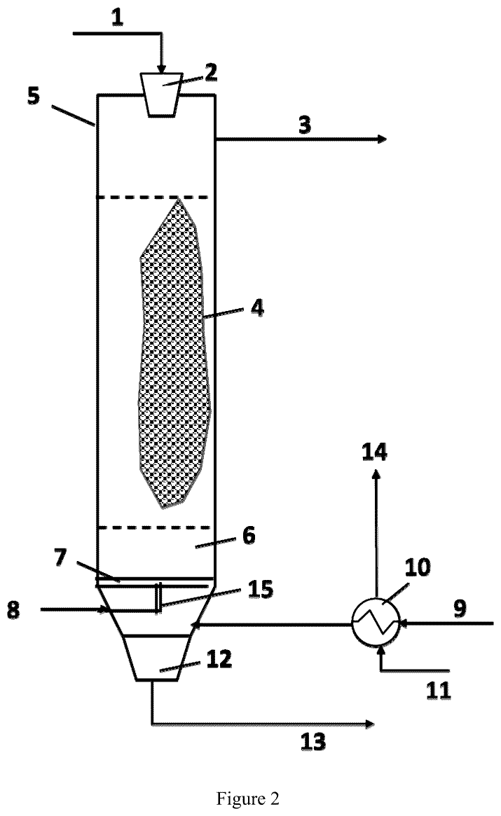

In one embodiment of the present invention, the reformer furnace is schematically illustrated in FIG. 2.

### Production Process

The invention provides a production process for direct raw material dry reforming of methane to co-produce metal oxides and syngas. In this process, methane feed gas is introduced into a reformer furnace (instead of a decomposition furnace) instead of traditional coal. Part of methane is used as fuel, and by regulating a content of oxygen, partial oxidation reaction of methane (see reaction formula 1) is carried out to release heat and supply energy, and a required temperature of the reformer furnace is provided and maintained without additional coal consumption, and carbon monoxide (CO) is produced. Other part of methane is used as a reaction raw material to undergo direct carbonate dry reforming of methane (see reaction formula 2) instead of a traditional thermal decomposition reaction of calcium carbonate (see reaction formula 3), and metal oxides such as calcium oxide and the like and syngas (H₂+CO) are co-produced without carbon dioxide emissions.

CH₄(g)=1.5O₂(g)→CO(g)+2H₂O(g)ΔH_{298K}=−520 kJ/mol (1)

CaCO₃(s)+CH₄(g)→CaO(s)+2CO(g)+2H₂(g)=426 kJ/mol (2)

CaCO₃(s)→CaO(s)+CO₂(g)ΔH_{298K}=179KJ/mol (3)

This process couples an exothermic partial oxidation reaction of methane and an endothermic direct dry reforming reaction of calcium carbonate and methane, which not only avoids emissions of CO₂ during decomposition process, but also directly utilizes partial oxidation of methane to provide heat for in-situ conversion of calcium carbonate decomposition. Calculations show that introduction of dry reforming of methane has a significant promotion effect on decomposition of carbonates. The reaction strengthens the temperature of calcium carbonate to produce calcium oxide (˜650° C.), which is far lower than the thermal decomposition temperature of carbonates (complete decomposition temperature ˜900° C.). By adjusting a feed ratio (methane/calcium carbonate), syngas with different H₂/CO ratios can be obtained by direct calcium carbonate dry reforming of methane. When a molar ratio of methane to calcium carbonate is (1.5-4):1, a ratio of hydrogen to carbon in syngas is (0.5-2):1. By adjusting a gas feed ratio (methane/oxygen), self-heating of a reaction system is realized, and energy consumption is further reduced.

A production process provided by the invention comprises: preheating raw material; subjecting carbonate in preheated raw material to direct carbonate dry reforming of methane to obtain metal oxides and high-temperature syngas; calcining the metal oxides to obtain cement clinker; and utilizing and separating waste heat of the high-temperature syngas. Further, the production process also comprises crushing and storing cement clinker, and the like.

Raw material is preheated in a preheater, heat required for preheating can come from high-temperature syngas generated by direct carbonate dry reforming of methane in a reformer furnace, and a temperature of the high-temperature syngas is 600-700° C. In one embodiment of the invention, the generated high-temperature syngas is discharged from a high-temperature syngas outlet of the reformer furnace and then enters the preheater, so that a temperature of raw material in the preheater is preheated to be 450-550° C.

In one embodiment of the invention, raw material is fed to the preheater with a feeding amount accurately controlled by a feeder; and the feeder can be in various feeding forms such as a screw feeder, an air-lock feeder and the like. In one embodiment of the invention, a feeding amount of raw material stored in a feeding bin after grinding and homogenization is accurately controlled by the feeder.

In one embodiment of the present invention, a proportion of metal catalyst in raw material is 1-5 wt % based on a total weight of raw material. Catalyst can be directly used as cement clinker additives after reaction, so there is no need for subsequent treatment.

Methane feed gas and oxygen are simultaneously introduced into a reformer furnace, part of methane feed gas and oxygen undergo oxidation reaction, and released heat is used as a heat source to meet high temperature requirement of the reformer furnace; and part of methane feed gas and carbonates in preheated raw material entering the reformer furnace through a raw material pipeline undergo reforming reaction to be converted into high-temperature syngas, calcium oxide and other metal oxides in situ. In the reformer furnace, raw material flows from top to bottom, and feed gas such as methane feed gas and oxygen flow from bottom to top.

As used herein, “gas containing methane”, “methane-containing gas” or “methane feed gas” can be used interchangeably, and all refer to feed gas consisting of one or more of natural gas, coke oven gas, coal bed gas, refinery gas, oil field gas, methanol synthesis purge gas and Fischer-Tropsch synthesis purge gas.

Oxygen can be pure oxygen or treated air (for example, but not limited to, oxygen purity above 99%).

Methane feed gas entering a reformer furnace is preheated by high-temperature flue gas generated by a rotary kiln, that is, the high-temperature flue gas generated by the rotary kiln enters the reformer furnace through a high-temperature flue gas inlet to preheat methane feed gas. In one embodiment of the present invention, high-temperature flue gas and methane feed gas pass through a heat exchanger disposed between the reformer furnace and the rotary kiln (outside the reformer furnace) through respective pipelines, and methane feed gas may be preheated to a temperature of 400-500° C. In one embodiment of the present invention, a molar ratio of methane feed gas to high-temperature flue gas from the rotary kiln is (0.5-1.5):1; preferably 1:1.

In one embodiment of the invention, a temperature of high-temperature flue gas generated in the rotary kiln is 1100-1300° C.

In one embodiment of the present invention, oxygen is quickly mixed with preheated methane feed gas through a burner to cause a combustion reaction instantaneously, and then enters a combustion chamber and the combustion chamber has enough space so that oxygen can be completely combusted in the combustion chamber. Combusted feed gas (referring to CO and CO₂ produced by an oxidation reaction between part of preheated methane feed gas and oxygen, as well as remaining methane) enters a catalytic reaction bed for dry reforming of methane. Heat required for the catalytic reaction bed comes from heat released by a partial oxidation and combustion of methane feed gas in the combustion chamber. Carbonates in raw material can be directly subjected to dry reforming with methane feed gas to produce metal oxides such as calcium oxide and high-temperature syngas.

In one embodiment of the present invention, a temperature of a reformer furnace is maintained at 600-700° C.

In one embodiment of the present invention, a feed molar ratio of methane feed gas to oxygen is (1.5-3.5):1.

In one embodiment of the present invention, a molar ratio of methane feed gas to carbonates in raw material is (1.5-4.0):1.

According to a production process provided by the present invention, a reaction between raw material and methane can achieve a conversion rate of over 90% (calculated based on a conversion of carbonates in raw material) in a reformer furnace, and even achieve a conversion rate of over 95%, with a reaction residence time of 10 s-60 s. A calculation method of conversion rate can be carried out according to the routine in this field, such as

$$Conversion rate of carbonates in raw material = \frac{Discharge quality of carbonates}{Feed quality of carbonates} \times 100 \%$$

High-temperature syngas generated by a reformer furnace enters a preheater through a high-temperature syngas outlet at an upper part of the reformer furnace for preheating carbonates in raw material, waste heat of syngas is recovered through a boiler connected with the reformer furnace, and finally syngas product is separated through a separation tower.

In one embodiment of the present invention, syngas product is obtained by separating syngas with a temperature of 200-350° C. that has undergone heat exchange through a preheater.

As used herein, “syngas” refers to a gas primarily composed of carbon monoxide and hydrogen. In one embodiment of the present invention, the obtained syngas product can be used as feed gas for a series of chemical raw materials, including but not limited to ammonia and its products, methanol and its products, hydroformylation products, etc. In one embodiment of the invention, a molar ratio of H₂ to CO in the obtained syngas product is (0.5-2):1.

According to a production process provided by the present invention, a selectivity of the reaction between raw material and methane into syngas can reach approximately 98% or more, or even nearly 100%. A calculation method of selectivity can be carried out according to the routine in this field, such as

$$Selectivity of synthesis gas = \frac{Content of CO at outlet + Content of {H}_{2} at outlet}{Content of CO at outlet + Content of {H}_{2} at outlet + Content of {CO}_{2} at outlet} \times 100 \%$$

In one embodiment of the invention, a temperature of a cement raw material preheated by a syngas heat exchanger at an outlet is 450-550° C. by dry reforming method of methane, and cement raw material enters a reformer furnace through a cement raw material inlet; a temperature of the reformer furnace is 600-700° C.; a molar ratio of methane feed gas to carbonates is (1.5-4.0):1, and a molar ratio of methane feed gas to oxygen is (1.5-3.5):1; and a temperature of preheated methane feed gas is 400-500° C., which is heated in a methane preheating heat exchanger by high-temperature flue gas from an outlet of a rotary kiln.

Metal oxides generated by a reformer furnace enters a rotary kiln through a metal oxide pipeline connected with a discharge outlet, is calcined with silicon oxide and the like at high temperature to form cement clinker, and is crushed and stored after being cooled by a grate cooler. Calcination can be carried out in a rotary kiln commonly used in the art.

In one embodiment of the present invention, gas conveying process in a production process is powered by an induced draft fan or a blower, and the gas is transported in a form of a pipeline.

A process and a system for co-producing metal oxides such as calcium oxide and the like and syngas by direct calcium carbonate dry reforming of methane provided by the invention can be applied to but not limited to cement industry, and also provide a universal technical scheme and a way for various carbonates decomposition production industries, for example but not limited to, quicklime preparation industry, building material industry, etc.

The above-mentioned features in the present invention, or the features mentioned in the embodiments, can be combined arbitrarily. All features disclosed in this specification can be combined with any combination form, as long as there is no contradiction in the combination of these features, and all possible combinations should be considered within the scope of this specification. The various features disclosed in the specification can be replaced by any alternative feature that can provide the same, equal, or similar purpose. Therefore, unless otherwise specified, the disclosed features are only general examples of equal or similar features.

The process and system for direct carbonate dry reforming of methane in cement production process based on carbon neutrality provided by the present invention can not only alleviate the problem of high carbon emissions in China's cement production process, but also enable its resource utilization, which is of great significance for carbon neutrality in industrial process.

Compared with existing cement production process, the present invention has the following advantages and beneficial effects:
1. A production process provided by the present invention solves the problem of the inability to avoid the generation of a large amount of CO₂ during the decomposition of calcium carbonate in raw material of decomposition furnaces in traditional cement production process. It uses methane-containing reducing gas and carbonates to directly undergo dry reforming reduction of methane in a reformer furnace to obtain metal oxides and syngas. It is a new cement production preparation process and equipment system that can reduce CO₂ emissions during carbonates decomposition process, which is of great significance for carbon reduction and carbon neutrality.
2. The present invention uses methane instead of coal to provide energy for the process, and utilizes the heat released from partial oxidation of methane to provide heat for the endothermic reaction of directly methane reforming of carbonates, achieving self-supply of heat in the reformer furnace. This not only solves the heating problem of the reformer furnace, but also reduces the additional carbon emissions generated by coal combustion.
3. The present invention prepares metal oxides and syngas through direct carbonate dry reforming of methane, which not only solves the problems of difficult decomposition and high energy consumption in industrial carbonates, but also achieves high-value utilization of industrial carbon resources. The generated syngas is used as raw material for chemical production platforms, resulting in higher added value and better economic efficiency of the process.
4. The present invention utilizes a reducing agent containing methane to reduce and decompose calcium carbonate, significantly reducing the decomposition temperature of calcium carbonate by up to 200-250° C., and greatly shortening the reaction time, resulting in a significant reduction in process energy consumption.
5. The generated high-temperature syngas can be used for preheating of calcium carbonate raw material in raw material and heat recovery, reducing the energy consumption of the entire system.

The production process provided by the present invention integrates high-temperature calcination of carbonates decomposition and efficient resource utilization of carbon dioxide, with the characteristics of low energy consumption and high efficiency, solving the bottleneck problem of large CO₂ emissions generated by carbonates decomposition in existing cement production processes.

The invention is further described below in conjunction with specific embodiments. It should be understood that these examples are merely for illustrative purposes and not intended to limit the scope of the disclosure. For the experimental methods without specific conditions indicated in the following examples, the conventional conditions or the conditions suggested by the manufacturer are usually followed. Unless otherwise specified, all percentages, ratios, proportions, or portions are measured by weight. The units in weight to volume percent in the present invention are well known to those skilled in the art, and for example, refer to the weight of solute in 100 milliliters of solution. Unless otherwise defined, all professional and scientific terms used herein have the same meanings familiar to those skilled in the art. In addition, any methods and materials similar or equivalent to those described may be applied to the methods of the present disclosure. The preferred embodiments and materials described herein are for exemplary purposes only.

### Example 1

Raw material of a cement plant is used as a sample. A mass ratio of limestone in the raw material is 91%, and the rest is calibration raw material such as steel slag containing Fe and Ni oxides. Among them, Fe and Ni oxides can be used as catalyst simultaneously to enhance the catalytic conversion of calcium carbonate in dry reforming of methane. After the reaction, the catalyst can be directly used as a cement raw material additive without the need for subsequent complex processing. The configured raw material is ground and homogenized and stored in the feeding bin. The feeding amount is accurately controlled by an air-lock feeder and the raw material is conveyed to the preheater for preheating and drying. The preheater provides heat through heat exchange from the high-temperature syngas (650° C.) discharged from the reformer furnace. After preheating and drying, a temperature of the raw material is 500° C., and it is sprayed into the reformer furnace through the upper inlet (a feed inlet). Methane and oxygen are introduced into the reformer furnace from the bottom in a molar ratio of 2:1. The high-temperature flue gas of 1250° C. discharged from the rotary kiln is used to preheat the methane feed gas through the heat exchanger. A temperature of the preheated methane raw gas reaches 500° C. Then the preheated methane feed gas and oxygen undergo partial oxidation reaction to generate heat, providing the required heat for the conversion reaction and maintaining the temperature of the reformer furnace at 650° C. The reaction between quicklime (calcium carbonate) and methane can achieve a conversion rate of 95% in the reformer furnace. The metal oxides such as calcium oxide obtained from the conversion of calcium carbonate are transported from the reformer furnace to the rotary kiln, and then calcined at high temperature according to the original production route to form clinker. After being cooled by a grate cooler connected to the kiln head, the clinker is crushed and stored. At the same time, the selectivity of the conversion of methane and calcium carbonate into syngas (CO+H₂) is nearly 100%, and the outlet gas of the reformer furnace is high-temperature syngas (650° C.). The high-temperature syngas passes through the preheater to provide heat for heating the raw material. After the temperature drops to 300-320° C., the syngas product (CO:H₂=1:1) is separated through the separation tank.

### Example 2

As shown in FIG. 2, the reformer furnace reactor system proposed in the present invention comprises: raw material pipeline 1, feed inlet 2, high-temperature syngas outlet 3, catalytic reaction bed 4, reactor furnace body 5, combustion chamber 6, gas distributor 7, oxygen inlet 8, methane feed gas inlet 9, heat exchanger 10, high-temperature flue gas inlet 11, discharge outlet 12, metal oxide outlet 13, and flue gas outlet 14. The feed inlet 2 is used to add raw material to the reformer furnace, and the discharge outlet 12 is used to discharge metal oxides. Heat exchanger 10 is used for heat exchange of high-temperature flue gas (1250° C.) from the rotary kiln, and preheating methane gas to 400-500° C. The outlet of the oxygen pipeline is a burner 15, which is for rapidly mixing oxygen with the methane raw gas in a certain proportion to cause an instantaneous combustion reaction. The combustion chamber 6 serves as an oxidation zone of methane to provide heat for direct carbonate dry reforming of methane, and to consume all oxygen. After combustion, the feed gas enters the catalytic reaction bed 4 for conversion reaction, the temperature is maintained at 650° C., and calcium carbonate in the raw material and methane are subjected to dry reforming under the action of the catalyst premixed in the raw material to generate metal oxides such as calcium oxide and the like and syngas, so that the carbonates is decomposed, and no carbon dioxide is discharged in the reformer furnace.

The above description is only a preferred embodiment of the present invention and is not intended to limit the scope of the essential technical content of the present invention. The essential technical content of the present invention is broadly defined within the scope of the claims of the application. Any technical entity or method completed by others that is completely identical to the scope of the claims of the application, or an equivalent modification, will be deemed to be included within the scope of the claims.

1. A method for producing cement clinker, wherein the method comprises the following steps: converting carbonate in a raw material into metal oxides by means of dry reforming of methane, and then calcining the metal oxides to form cement clinker.

2. The method of claim 1, wherein the method further obtains syngas through the dry reforming of methane.

3. The method of claim 1, wherein heat required for the dry reforming of methane is generated by subjecting methane feed gas to partial oxidation reaction of methane.

4. A production system for cement clinker, wherein the system comprises a preheater, a reformer furnace, a rotary kiln and a grate cooler arranged in sequence in a direction of material flow.

5. The production system of claim 4, wherein the reformer furnace comprises a furnace body, a syngas heat exchanger at an outlet, a methane feed gas preheating heat exchanger at an inlet; besides, a cement raw material inlet, a syngas outlet, a catalytic reaction bed, a combustion chamber, a preheated methane feed gas inlet, an oxygen inlet and a cement clinker discharge outlet are arranged in the furnace body from top to bottom.

6-7. (canceled)

8. A method for preparing cement clinker using the production system of claim 4, wherein the method comprises the following steps:
(1) feeding raw material preheated by the preheater into the reformer furnace through a cement raw material inlet and converting into metal oxides through dry reforming of methane;
(2) calcining the metal oxides in the rotary kiln to obtain cement clinker.

9. The method of claim 8, wherein a syngas with a temperature of 600-700° C. produced by a conversion reaction in the reformer furnace preheats a temperature of raw material in the preheater to 450-550° C.

10. The method of claim 8, wherein part of heat required for a conversion reaction in the reformer furnace comes from partial oxidation reaction of a preheated methane feed gas and oxygen introduced into a lower part of the reformer furnace.

11. The method of claim 10, wherein a molar ratio of the preheated methane feed gas introduced into the lower part of the reformer furnace, the introduced oxygen and carbonates in raw material is (1.5-4.0):(1.5-3.5):1.

12. The method of claim 1, wherein the method comprises the following steps:
preheating the raw material;
subjecting the preheated raw material to the dry reforming of methane in a reformer furnace, to obtain metal oxides and a high-temperature syngas; and
calcining the metal oxides to form cement clinker;
wherein a temperature of the dry reforming of methane is 600-800° C.;
wherein a methane feed gas and oxygen are simultaneously introduced into the reformer furnace, part of the methane feed gas and oxygen undergo oxidation reaction, and released heat is used as a heat source for the dry reforming of methane.

13. The method of claim 12, wherein a molar ratio of the methane feed gas, oxygen and carbonate is (1.5-4.0):(1.5-3.5):1.

14. The method of claim 12, wherein the raw material is preheated to a temperature of 450-550° C.

15. The method of claim 12, wherein a temperature of the high-temperature syngas is 600-700° C.

16. The method of claim 12, wherein the raw material is preheated by the high-temperature syngas.

17. The method of claim 12, wherein the temperature of the dry reforming of methane is 650-800° C.

18. The method of claim 12, wherein a methane feed gas entering the reformer furnace is preheated to a temperature of 400-500° C. by a high-temperature flue gas generated by a rotary kiln, and a temperature of the high-temperature flue gas is 1100-1300° C.

19. The method of claim 8, wherein a temperature of the dry reforming of methane is 600-800° C.

20. The method of claim 8, wherein a methane feed gas and oxygen are simultaneously introduced into the reformer furnace, part of the methane feed gas and oxygen undergo oxidation reaction, and a released heat is used as a heat source for the dry reforming of methane.

21. The method of claim 8, wherein the temperature of the dry reforming of methane is 650-800° C.

22. The method of claim 8, wherein a methane feed gas entering the reformer furnace is preheated to a temperature of 400-500° C. by a high-temperature flue gas generated by a rotary kiln, and a temperature of the high-temperature flue gas is 1100-1300° C.
